(19) United States
(12) Patent Application Publication
(10) Pub. No.: US 2016/0241497 A1
(43) Pub. Date: Aug. 18, 2016

(54) INVOKING AN APPLICATION TO PERFORM A SERVICE BASED ON MESSAGE CONTENT

(71) Applicant: Alibaba Group Holding Limited, George Town (KY)

(72) Inventors: Zhijun Yuan, Hangzhou (CN); Fan Wu, Hangzhou (CN)

(21) Appl. No.: 15/041,003

(22) Filed: Feb. 10, 2016

(30) Foreign Application Priority Data
Feb. 13, 2015 (CN) 201510080218.7

(51) Int. Cl. H04L 12/58

(52) U.S. Cl. CPC H04L 51/046

(57) ABSTRACT

Invoking an application to perform a service based on message content is disclosed, including: obtaining content from a message received at a device; extracting situation-feature information from the content; generating one or more application-entry objects based at least in part on the situation-feature information; presenting the one or more application-entry objects at the device; receiving an indication that an application-entry object among the one or more application-entry objects is to be activated; and in response to an activation of the application-entry object, invoking an application to perform a service corresponding to the application-entry object.

### CROSS REFERENCE TO OTHER APPLICATIONS

This application claims priority to People's Republic of China Patent Application No. 201510080218.7 entitled A METHOD AND A DEVICE FOR PROCESSING TEXT INFORMATION, filed Feb. 13, 2015 which is incorporated herein by reference for all purposes.

### FIELD OF THE INVENTION

The present application relates to the field of computer technology. In particular, the present application relates to techniques for processing message content.

### BACKGROUND OF THE INVENTION

With the rapid development of mobile Internet technologies, people are using mobile devices more and more frequently. The prevalence of using mobile devices has also led people to commonly send and receive information over their mobile devices. Common examples of information that is sent and received over mobile devices include text messages and instant-messaging messages. Therefore, using mobile devices to exchange information is an extremely important function.

A common form of communication via mobile devices is text messages. While users use various services to communicate with coworkers and friends, text messaging is the medium of choice used by coworkers, friends, and even service providers to send the details of activities to users.

However, text messages with ordinary text are not convenient for looking up additional, relevant information. For example, if users also need other services related to the content of a text message, they will have to use the text message content as a basis for searching for corresponding application programs in order to meet their needs.

### BRIEF DESCRIPTION OF THE DRAWINGS

Various embodiments of the invention are disclosed in the following detailed description and the accompanying drawings.

FIG. 1 is a diagram showing an embodiment of a system for invoking an application to perform a service based on message content.

FIG. 2 is a flow diagram showing an embodiment of a process for invoking an application to perform a service based on message content.

FIG. 3 is a diagram showing an example of a user interface at a device that displays multiple application-entry objects that have been generated from a text message.

FIG. 4 is a flow diagram showing an example process of obtaining content from a message received at a device that is executing an Android operating system.

FIG. 5 is a flow diagram showing examples of extracting one or more pieces of situation-feature information from content obtained from a message.

FIG. 6 is a diagram showing an embodiment of a device for invoking an application to perform a service based on message content.

FIG. 7 is a functional diagram illustrating an embodiment of a programmed computer system for invoking an application to perform a service based on message content.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of invoking an application to perform a service based on message content are described herein. Content (e.g., text, audio, images, and/or video) is obtained from a message that is received at a device. One or more pieces of situation-feature information are extracted from the content. In various embodiments, a piece of “situation-feature information” comprises a key piece of information that describes an activity or an event. In some embodiments, additional information is determined based on the one or more pieces of situation-feature information. In various embodiments, additional information comprises information that is pertinent to and/or omitted from the message and can be used to supplement the one or more pieces of situation-feature information. In various embodiments, one or more application-entry objects are generated based at least in part on the one or more pieces of situation-feature information and/or the additional information. In response to an activation of one of the presented application-entry objects, an application to perform a service corresponding to the activated application-entry object associated with the activated application-entry object is invoked.

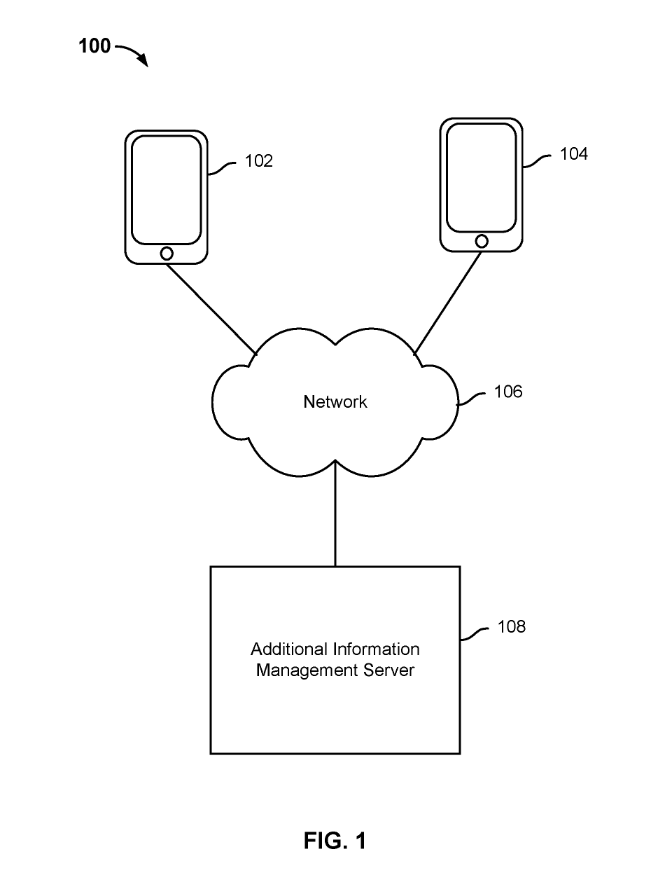

FIG. 1 is a diagram showing an embodiment of a system for invoking an application to perform a service based on message content. In the example, system 100 includes device 102, device 104, network 106, and additional information management server 108. In some embodiments, network 106 comprises high-speed data and/or telecommunications networks.

Device 104 is configured to receive messages. While device 104 is shown to be a smart phone, other examples of device 104 include a mobile device, a tablet device, a desktop computer, a laptop device, or other computing device. For example, a received message may comprise a text message or an instant messaging message. The message may include text, images, audio, and/or video, for example. Device 104 may have received the message from another device, such as device 102, or a server (not shown in the diagram), over a network such as network 106.

In some embodiments, device 104 (or an application executing thereon) is configured to obtain the content from the received message and extract pieces of situation-feature information from the content. In some other embodiments, device 104 can forward the message to additional information management server 108, over network 106, for additional information management server 108 to obtain the content from the received message and extract pieces of situation-feature information from the content. In some embodiments, one or both of device 104 and additional information management server 108 can determine additional information to supplement the pieces of situation-feature information based on the pieces of situation-feature information. Device 104 is configured to generate and present application-entry objects based at least in part on the pieces of situation-feature information and the additional information. A user of device 104 may activate an application-entry object that is presented at device 104 (e.g., through selecting the application-entry object). In response to the activation of the application-entry object, an application to perform a service corresponding to the activated application-entry object is invoked by, in some embodiments, at least sending a piece of situation-feature information and a portion of the additional information associated with the activated application-entry object to the application. The application may be executing at device 104 or accessible via a web browser at a separate server (not shown in the diagram).

As will be described in further detail below, embodiments of invoking an application to perform a service based on message content are described herein and enable application-entry objects to be automatically generated from the content of a message received at a device. Application-entry objects describe services that are to be performed by applications based on situation-feature information that is extracted from the content of the message. A user can therefore activate a presented application-entry object to invoke an application to perform a helpful task on behalf of the user using information provided in the original message and/or additional information that is determined to supplement the information that is in the original message. For example, various application-entry objects can be presented to and then activated by a user to invoke an application to dial a phone number for a contact person, to request a taxi for a destination, to provide directions and/or a map for a destination, to add an event to a calendar, and so forth. Therefore, embodiments described herein free a recipient of a message from manually searching and/or requesting for services that can be derived from a received.

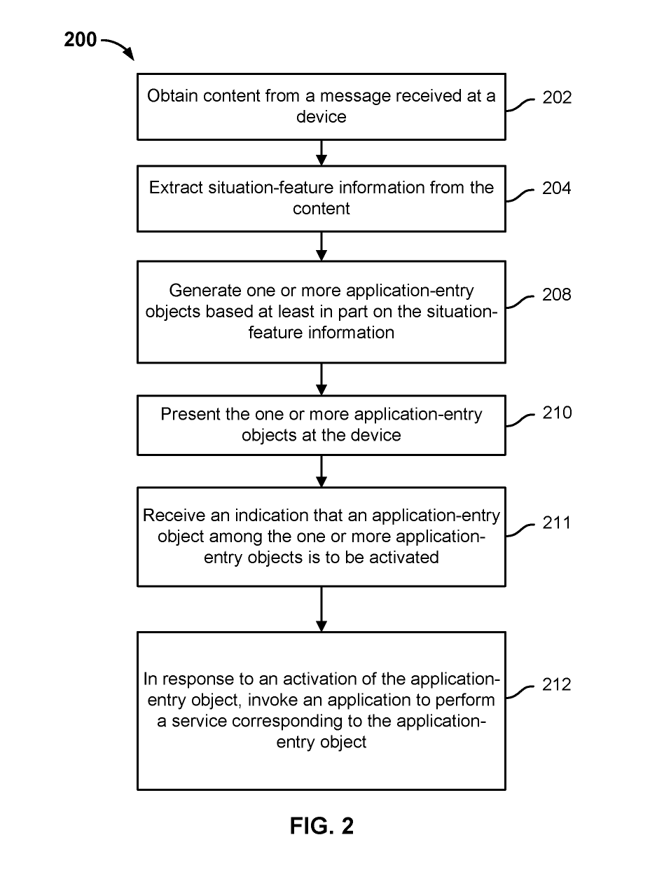

FIG. 2 is a flow diagram showing an embodiment of a process for invoking an application to perform a service based on message content. In some embodiments, process 200 is implemented at a system such as system 100 of FIG. 1. Specifically, in some embodiments, process 200 is implemented at device 104 of system 100 of FIG. 1.

At 202, content is obtained from a message received at a device.

For example, the device may comprise a personal digital assistant (PDA), a laptop computer, a tablet device, a personal computer, a desktop computer, and/or a palmtop computer. The device can support any type of operating system, including for example, Windows, Android, iOS, and Windows Phone. The operating system executing on the device can generally run various applications that perform various services. Such applications may include, for example, system applications, such as phone dialing service applications, navigation service applications, contact applications, calendar applications, etc. Other applications may also include third party applications such as browsers, taxi requesting service applications, and electronic maps, for example. In various embodiments, process 200 is implemented by either a system application or a third party application executing at the device. Embodiments of the present application do not impose restrictions on the type of application that can be used to implement process 200.

In various embodiments, content is extracted from the body of a message that is received at the device by an application implementing various embodiments described herein. In various embodiments, the content may be in any form, including images, audio, and/or text. For example, the message that is received at the device comprises a text message, an instant-messaging message, and/or an email, etc. Embodiments of the present application do not impose restrictions on the type of message that is received at the device.

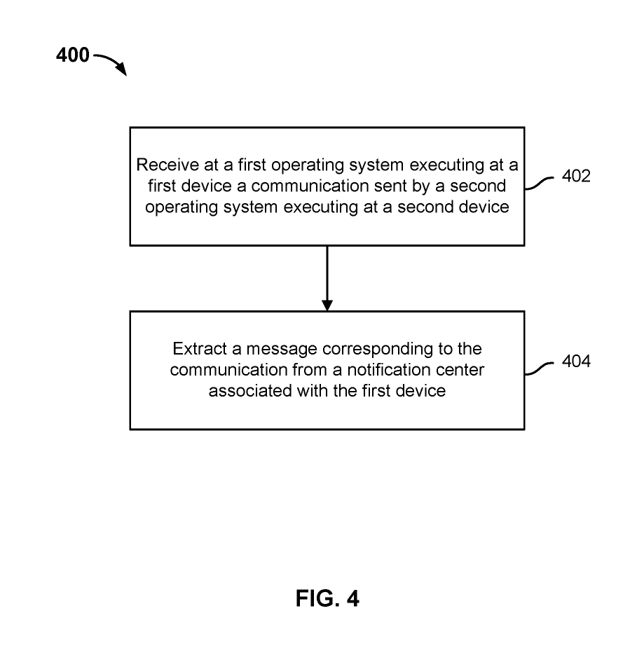

Text messages and instant messaging messages are types of text information that are generally more frequently used and different operating systems may acquire text messages in different ways. FIG. 4, below, provides an example that describes receiving and obtaining the content from text and/or instant messaging messages at a device that is running the Android operating system.

While the content obtained from the message may comprise text, image(s), and/or video(s), for purposes of illustration, various examples described herein refer to the text information content that is obtained from the received message.

Embodiments of the present application impose no restrictions on the source and formatting of the text information in the received message. For example, the text information may come from a predetermined source (e.g., text messages from one or more specified codes, instant-messaging messages from one or more specified account numbers, and emails from one or more specified addresses) or the text information may come from a non-predetermined source (e.g., text messages from one or more non-specified codes, instant-messaging messages from one or more non-specified account numbers, and emails from one or more non-specified addresses).

If the text information obtained from the received message originates from certain businesses/government offices, the text information may be a notification associated with a service and is therefore associated with standardized formatting. As used herein, the term “origin” may refer to the initial sender system of the text information. For example, an “origin” may be a server or it may be a mobile terminal or something else but it does not refer to a network node or a server that plays a forwarding/intermediate role.

The following is an example of a ticket purchase notification that is sent as two text messages from a railway service:

“(1/2) Order No. E440674001, Ms. Li, you purchased: June 27, No. G7509, Car 4, Seat 08C, Departing Shanghai Hongqiao 11:00. May carry second-generation identification [Railway Customer Service]” and

“(2/2) for direct ticket inspection and boarding or exchange for paper train ticket and then board. [Railway Customer Service]”

The format of the messages includes: an order number, a honorific (e.g., Mr./Ms.), a date, a train number, a departure location, a departure time, and necessary information relating to ticketing.

If the text information originated from, for example, certain individuals, then the formatting of its overall content will typically be non-standardized.

The following is an example of a text message that is received from an individual (not a service) and that includes non-standardized text information:

“Already booked tomorrow's flight for you. The flight number: CA1703.”

In some embodiments, since messages generally involve user privacy, some operating systems or applications may require that the user grant use authority before content can be obtained from messages. Therefore, in some embodiments, user authorization is obtained prior to obtaining content from messages. User authorization can be obtained in one of the following example manners:

First, via a tool such as, for example, a settings/configuration application provided by the operating system, the user inputs a selection to grant access authority for a particular text information source (e.g., text messaging center, instant-messaging tool, or mailbox client).

Second, the user inputs a selection to accept a user agreement associated with authorizing the access to messages associated with one or more information sources. To safeguard the user's right to be informed, in some embodiments, a user agreement can specify that one or more text-information sources can be accessed to acquire text information.

At 204, situation-feature information is extracted from the content.

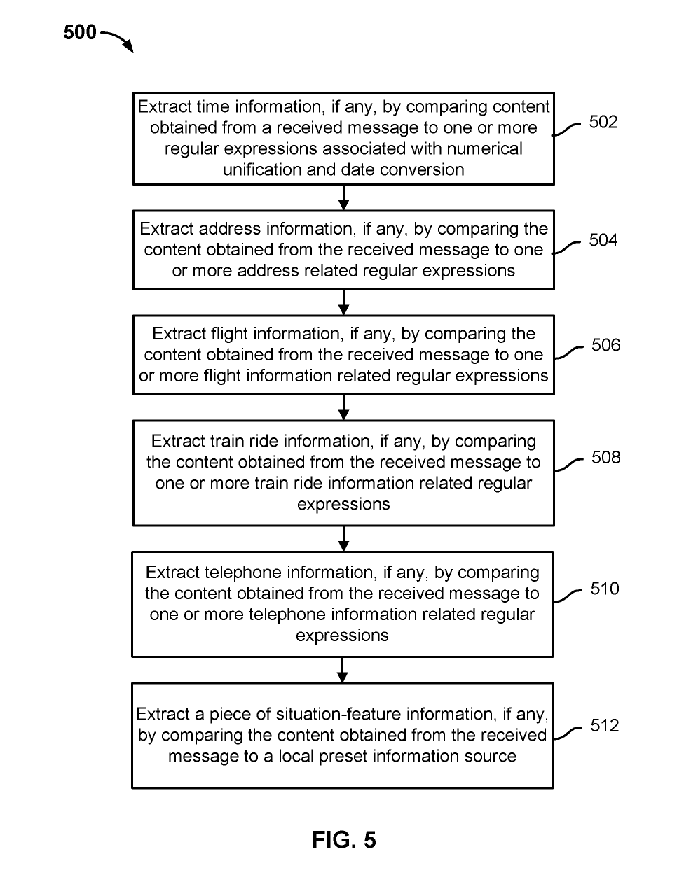

In various embodiments, a piece of “situation-feature information” refers to information that characterizes features of one or more situations. In various embodiments, a “situation” comprises an event and/or an activity of a particular category. In some embodiments, the event and/or activity of situation-feature information is associated with the following one or more categories: time, address, flight number, train number, telephone number, contact person, video title, etc. A piece of situation-feature information is generally key information in a message that the user pays attention to. In various embodiments, the obtained content (e.g., text information) of a received message may include one or more pieces of situation-feature information. In some embodiments, the situation-feature information may be extracted at the device or the content of the received message may be sent to a remote additional information management server and extracted by the server. FIG. 5, below, provides examples regarding extracting situation-feature information from the content of a received message.

For example, text information obtained from a received message is “Already booked tomorrow's flight for you. The flight number: CA1703.” This text information pertains to the situation of flying as a passenger in an airplane as can be determined by comparing flight information regular expressions to the text information, for example, as will be described further below with FIG. 5.

In another example, the obtained text information is “Come to International Plaza in Xihu District for a meeting at 8:30 tomorrow morning. Please pass this information on to Jimmy.” This text information contains the situation of a meeting.

In yet another example, the obtained text information is “Tomorrow, you'll see The Taking of Tiger Mountain, right?” This text information contains the situation of going to see a movie.

In some embodiments, there are at least two types of situation-feature information. The two types are as follows:

The first type of situation-feature information includes regular-text formatting. For example, situation-feature information with regular-text formatting is identifiable using data stored locally at the device and can be directly identified based on standardized text formatting, its information source, and/or by some other manner applied locally at the device.

For example, the first type of situation-feature information may comprise one or more of the following categories:

time, address, flight number, train number, telephone number, a contact person, etc.

The second type of situation-feature information includes irregular-text formatting. In some embodiments, a large volume of sample information is collected in advance in the background (e.g., by a server) and the situation-feature information is identified using the large volume of collected sample information in the background (e.g., by a server). For example, the large volume of sample information can be used as training sets in machine learning to generate models that can recognize situation-feature information inside text information.

For example, the second type of situation-feature information may comprise a video title.

The types of situation-feature information described above are examples only. Embodiments of the present application impose no restrictions on the types of situation-feature information that can be identified from the content of a message.

In many circumstances, the situation-feature information that is included in a message may be only partial situation-feature information because there are omissions of details that would more clearly define the situation-feature information.

For example, the text information in a received message is “Already booked tomorrow's flight for you. The flight number: CA1703.” Thus, in this situation of being a passenger on an airplane, there are two pieces of situation-feature information: “tomorrow” and “CA1703.” The departure address, destination address, departure time, arrival time, captain, crew, and other such information associated with being a passenger on an airplane are missing.

In various embodiments, additional information associated with the situation-feature information identified from the content of a received message is automatically determined. In various embodiments, the additional information associated with the situation-feature information identified from the content of the received message supplements the information that is already included in the situation-feature information. As such, in some embodiments, the additional information associated with the situation-feature information identified from the content of a received message is also referred to as “supplementary information.”

In various embodiments, such additional information may comprise information that is missing from the situation-feature information that is obtained from the content of the received message. As will be described in further detail below, the additional information is determined based on the situation-feature information that is obtained from the content of the received message. For example, the additional information may comprise information that the user pays attention to, information that has a dependent relationship vis-à-vis the situation-feature information, and/or information that can be derived from the situation-feature information and that can more completely provide the context of the situation associated with the message.

For example, the text information obtained from the received message is “Already booked tomorrow's flight for you. The flight number: CA1703.” Thus, in this situation associated with being a passenger on an airplane, there are two pieces of situation-feature information: “tomorrow” and “flight number: CA1703.” For example, the two pieces of situation-feature information can be determined by comparing flight information regular expressions to the text information, as will be described further below with FIG. 5. As such, the following information can be determined based on the identified pieces of situation-feature information as supplementary information: departure address, destination address, departure time, arrival time, etc. Other additional information that is missing such as that relating to the captain and crew can be optionally determined.

In various embodiments, associative relationships between pieces of situation-feature information and required supplementary information may be predetermined in advance of executing process 200. Then, during an execution of process 200, additional information associated with the situation-feature information that is identified from the content of a received message is determined based at least in part on these predetermined associative relationships between pieces of situation-feature information and required supplementary information. In some embodiments, if at least a portion of the required supplementary information corresponding to the situation-feature information is already present in the content (e.g., text information) of the received message, then that portion of the required supplementary information does not need to be returned/determined as additional information.

An example of associative relationships between situation-feature information and required supplementary information may be as shown in Table 1, below:

TABLE 1

| Situation-feature | Required supplementary |
|---|---|
| information | information |
| Flight number | Departure location, destination, flight |
| | departure time, arrival time |
| Train number | Train schedule |
| Contact person | Telephone number of contact person |
| Video title | Movie review, bios of leading actors |

If the content of the received message includes at least one piece of situation-feature information, then it is possible that the at least one piece of situation-feature information could be incomplete and/or could fail to express the situation very well. In various embodiments, one or more pieces of additional information can be determined based on the pieces of situation-feature information and then presented with the original message to provide more context and also supplement the original information that was included in the message.

In some embodiments, the device can send the at least one piece of situation-feature information to a remote additional information management server and the remote server can determine one or more pieces of additional information to supplement the situation-feature information. In some embodiments, various types of additional information could be collected in advance and stored for various categories at a server as one or more data sets. The remote server can then look up additional information to supplement the situation-feature information from such data sets. As such, the at least one piece of situation-feature information can be used as a keyword in performing searches among the stored data sets. In some embodiments, the remote server can also use any predetermined associative relationships between situation-feature information and required supplementary information (e.g., such as the example relationships described in Table 1, above) to determine additional information. For example, if the situation-feature information comprises flight information, then the remote server would search a flight status website or database for whichever ones of departure location, destination, flight departure time, and arrival time corresponding to that flight information that are not already included in the flight information. For example, in the case of flight related information, flight numbers, departure locations, destinations, departure times, and arrival times could be collected from the servers of each airline and then stored according to flight number at the additional information management server.

In some embodiments, the device at which the message is received can identify a category associated with each piece of situation-feature information. In some embodiments, the additional information management server can identify a category associated with each piece of situation-feature information.

For example, the situation-feature information “CA1703” complies with flight information related regular expression that is used for matching flight numbers. FIG. 5, below, describes additional examples of using flight information related regular expressions to extract flight information from the content of received messages. Thus, “flight number” may be considered as the category relating to the situation-feature information of “CA1703”.

One advantage of having the additional information management server determine the additional information to supplement the situation-feature information is that the volume of additional information associated with certain categories (e.g., associated with flight information such as flight numbers, train ride information such as train numbers, television show titles and cast members) can be large and it would be too space inefficient for a device to locally store such information.

For example, the server may collect a large volume of sample information. Examples of such sample information include the titles of movies and television shows, plots, movie reviews, leading actors or actresses, and other such information. This sample information may refer to information that serves as samples of the situation-feature information.

In some embodiments, in addition or alternative to sending the situation-feature information to the remote additional information management server, the one or more pieces of situation-feature information can be used as key words in performing searches locally at the device for additional information. Certain other categories of information are smaller in volume and are therefore more practically stored at the device. An example of such a category of information is information related to contacts of the user of the device. Such information is typically stored in the form of a contact list. As such, the at least one piece of situation-feature information can be used as keywords in performing searches in the contact list stored locally at the device. In some embodiments, the device can also use any predetermined associative relationships between situation-feature information and required supplementary information (e.g., such as the example relationships described in Table 1, above) to determine additional information. For example, if the situation-feature information comprises a contact person in the device's stored contact list, then the device would search for the telephone number corresponding to that contact person from the contact list.

In some embodiments, additional information to supplement the situation-feature information may be determined at both the remote additional information management server and the device and then combined.

In some embodiments, and as mentioned above, if at least a portion of the required supplementary information corresponding to the situation-feature information is already present in the content (e.g., text information) of the received message, then that portion of the required supplementary information does not need to be returned/determined as additional information. For example, it may be determined that the required supplementary information corresponding to a piece of situation-feature information is already present in the text information if after the required supplementary information is obtained, it is determined that the obtained required supplementary information is similar to or otherwise matches an existing portion of the text information. As such, in the event that all the required supplementary information corresponding to the situation-feature information is already present in the content of the message, then no additional information needs to be returned for the situation-feature information. This scenario could occur if the original content of the message provided a complete context for the described situation(s).

At 208, one or more application-entry objects are generated based at least in part on the situation-feature information.

In some embodiments, the category associated with the situation-feature information is used to determine a corresponding application-entry template. Each application-entry template corresponds to an associated application service. Example categories associated with the situation-feature information include time information, address information, flight information, train ride information, telephone information, and contact person information. In some embodiments, there are one or more applications associated with the same category of situation-feature information. In some embodiments, a uniform application-entry template can be used to generate application-entry objects for the same category of situation-feature information.

In various embodiments, an application-entry template comprises the permanent data within application-entry objects. In various embodiments, an application-entry template primarily comprises user interface (UI) elements, such as icons and text. In various embodiments, an application-entry template may also comprise data such as scripts, e.g. JavaScript Object Notation (JSON), for invoking a corresponding application.

In some embodiments, an application-entry template comprises user interface elements that form parameters to be used by a corresponding application to provide the associated application service corresponding to that template. In various embodiments, an “application-entry object” is generated using an application-entry template by embedding at least some of the situation-feature information and/or additional information as parameters in the user interface elements of an application-entry template. In various embodiments, “embedding” at least some of the situation-feature information and/or additional information as parameters in the user interface elements of an application-entry template comprises to replace some default and/or placeholder parameter values in the application-entry template with the situation-feature information and/or additional information. In various embodiments, at least some user interface elements of a generated application-entry object are presented when the application-entry object is presented. In various embodiments, an “application-entry object” comprises an application trigger point that when activated by a user (e.g., through user selection), triggers the execution of a corresponding application of an associated application service corresponding to the application-entry template on which the application-entry object was based and also transfers at least some of the parameters (comprising situation-feature information and/or additional information) to the executed corresponding application.

The following is an example of an application-entry template that is configured to invoke a navigation service application:

{

“class” : “Guide”,
“when” : 0,
“cache” : “loc:1000”,
“filter” : “package(com.autonavi.minimap)”,
“base” : true,
“simple” : false,
“static” : false,
“needLocation”: true,
“needAccount” : false,
“ispName” : “GAODE”,
“dataUrl” : “http://linkservice.aliapp.com/summary.json”,
“actionUrl” :

“androidamap://route?sourceApplication=com.yunos.lifecard&slat={result.data.slat}&slon={res
ult.data.slon}&sname=MyLocation&dlat={result.data.dlat}&dlon={result.data.dlon}&dname={r
esult.data.dest}&dev=0&m=0&t=2&showType=1”,

“titleExpr” : “Guide to {result.data.dest}”,
“subTitleExpr” : “Distance: {result.data.distance}KM TIME:

{result.data.duration}MINUTES”,

“imgURI” : “ic_connectedservices_location”,
“imgURIs” :

“http://dl.django.t.taobao.com/rest/1.0/image?fileIds=nMFMsZIFQ7uI6tY3c1DuLQAAAB8AA
QEC&zoom=60x60”,

“dataParams” : {

“destination” : “{card.content.orderDO.to}”,
“origin” : “{location}”

},
“userTrack” : “name=navi”

}

An application-entry object that is generated based on the example application-entry template above will include pieces of situation-feature information and/or additional information embedded within the “0” portions to replace the default/placeholder values that are currently included in the “0” portions of the template. The “actionUrl” command in the application-entry object refers to a map navigation service application, which will launch with the map navigation service application when a user activates (e.g., selects) the application-entry object after it is presented. At least some of the parameters of the application-entry object are also transferred to the invoked map navigation service application and used by the map navigation service application to provide the map navigation service.

For example, suppose that an application-entry template is associated with an application for providing a phone dialing service and includes a user interface element comprising the parameter of a contact person to call. Also, suppose that an application-entry object generated from the template has the situation-feature information of a contact person “Jennifer S.” embedded in a user interface element comprising the parameter of a contact person to call. In this example, once the presented application-entry object becomes activated by the user (e.g., through user selection), the phone dialing application will automatically dial the stored contact number for “Jennifer S.”

In some embodiments, correspondence may be established in advance among categories of situation-feature information, application-entry templates, and one or more associated application services. In various embodiments, associated application services refer to service(s) that can be provided by one or more applications.

Table 2, below, is example predetermined correspondences among categories of situation-feature information, application-entry templates, and one or more associated application service(s):

TABLE 2

| Situation-feature | Application-entry | Associated application |
|---|---|---|
| information | template | service(s) |
| Time | Calendar template, etc. | Add to calendar, etc. |
| Address | Weather template, taxi-booking | Weather, taxi-booking service, |
| | template, navigation template, etc. | navigation service, etc. |
| Flight number | Flight status template, online | Flight status, online check-in service, |
| | check-in template, etc. | etc. |
| Train number | Train schedule template, etc. | Train schedule information, etc. |
| Video title | Movie review template, leading | Movie review, leading actor/actress |
| | actor/actress bio template, etc. | bio, etc. |
| Telephone | Contacts template, text message | Add to contacts, Send text message, |
| number | template, dialing template, etc. | Dial this number, etc. |
| Contacts | Dialing template, text message | Dial number, Send text message, etc. |
| | template, etc. | |

In various embodiments, the application-entry template and the associated application service(s) corresponding to the situation-feature information are first determined from a set of predetermined correspondences (e.g., such as examples provided in Table 2, above). Then, the situation-feature information, the additional information determined based on the situation-feature information, if any, and the associated application service(s) corresponding to the situation-feature information are embedded as parameters into one or more user interface elements to generate one or more application-entry objects.

Each generated application-entry object can be identified as providing a service for the situation-feature information. In some embodiments, the situation-feature information can be embedded in a user interface element of an application-entry object with or without any additional information determined based on the situation-feature information.

For example, in the case of a taxi-booking service or a navigation service, the original situation-feature information that was extracted from the received message, even without any additional information, relating to the current address and destination address can be embedded in a user interface element to generate an application-entry object. But in the case of a number-dialing service, for example, the situation-feature information that was extracted from the received message that is supplemented with additional information relating to contacts and telephone numbers can be embedded in a user interface element to generate an application-entry object.

In some embodiments, at least a portion of the parameters of the application-entry object is determined based at least in part on the situation-feature information that was extracted from the received message and/or the additional information that is used to supplement the situation-feature information and/or current information associated with the device at which the message is received. Put another way, in some instances, some information included in the situation-feature information and/or the additional information and/or the current information associated with the device may be used to look up certain parameters to be embedded in user interface elements of the associated application service. For example, if the situation-feature information comprises an address, then parameters such as the routes, times, taxi fares, and other application-service information relating to a navigation service or a taxi-booking service may be determined in advance according to a current location of the device at which the message is received and the parameter of destination can be determined from the situation-feature information. Then, the combination of the parameters determined based on the current location of the device and the information that is determined from the situation-feature information is embedded in one or more user interface elements of a corresponding application-entry template to generate an application-entry object.

At 210, the one or more application-entry objects are presented at the device.

In some embodiments, the original message, the situation-feature information, additional information determined based on the situation-feature information, and/or the generated application-entry objects can be caused to be directly displayed (e.g., in an application, a system application or a third party application executing) at the device.

In some embodiments, the original message, the situation-feature information, additional information determined based on the situation-feature information, and/or the generated application-entry objects are first loaded into one or more card templates and then the loaded card template(s) comprise one or more card objects that are presented at the device. In various embodiments, a “card template” comprises a template that describes how the original message, the situation-feature information, additional information determined based on the situation-feature information, and/or the generated application-entry objects are to be presented at the device. In some embodiments, different card templates may be predetermined for different situation-feature information. Different card templates may include different situation-feature information display styles, such as different display positions and font styles for situation-feature information and application-entry objects. Therefore, corresponding card templates can be looked up in the predetermined correspondences for the given situation-feature information extracted from a received message. In various embodiments, a “card object” is generated by loading one or more of: at least a portion of the original message, the situation-feature information, additional information determined based on the situation-feature information, or the generated application-entry objects into a card template. In various embodiments, a “card object” comprises a presentation of situation-feature information, additional information that supplements the situation-feature information, and/or application-entry objects. For example, a card object comprises an image expression of an information set rather than a physical card.

The card object can organize the set of situation-feature information and application-entry object(s) according to a definite data model (also called data format) and display it on a user interface of the device. This way, at least some of the extracted situation-feature information can be displayed along with the generated application-entry objects at the device such that the user of the device can view the extracted situation-feature information along with any automatically generated application-entry objects that the user can activate. For example, JavaScript Object Notation (JSON) may be used to implement card templates/objects.

For example, the following is an example card template:

{
“headview”:$title$,
“bodyview”:$description$
}

In a simple example, if the following is data to be included in a card object:

{
“title”: “this is title”,
“description”: “this is description”
}

Then a resulting card object generated based on the above example card template and card data is the following:

{
“headview”: “this is title”,
“bodyview”: “this is description”
}

The generated card objects are then displayed at the device.

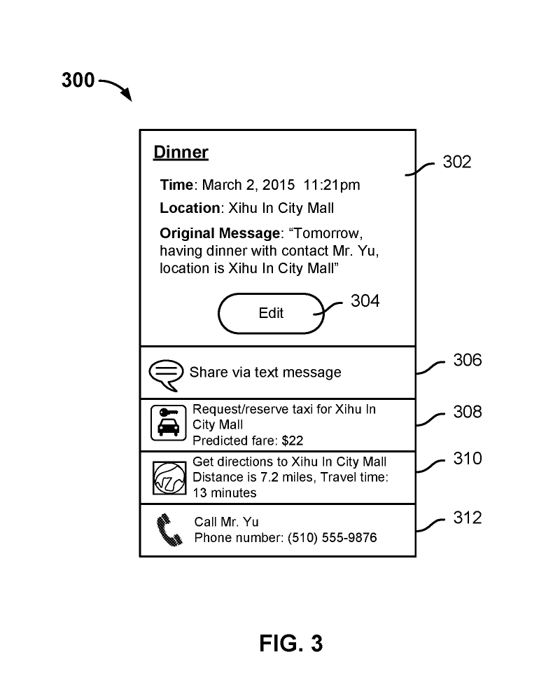

FIG. 3 is a diagram showing an example of a user interface at a device that displays multiple application-entry objects that have been generated from a text message. User interface 300 of the example can be presented at the device at which a message was received. The text message of the example comprises “Tomorrow, having dinner with contact Mr. Yu, location is Xihu In City Mall” and the following pieces of situation-feature information were extracted from the text message: the time of “tomorrow,” the contact “Mr. Yu,” and the address of “Xihu In City Mall.” Additional information to supplement the extracted situation-feature information may determine the address of Xihu In City Mall and also the stored phone number of contact “Mr. Yu.” Therefore, a corresponding application-entry object was generated based on each piece of extracted situation-feature information and any corresponding additional information. As shown in the diagram, the original text message and some of the extracted pieces of situation-feature information are displayed in area 302 of user interface 300. In the example of FIG. 3, user interface 300 comprises the original message, the situation-feature information, additional information determined based on the situation-feature information, and the generated application-entry objects being displayed within corresponding card objects. For example, area 302 comprising the original message and extracted situation-feature information comprises a card object and each of application-entry objects 306, 308, 310, and 312 is displayed as a corresponding card object. “Edit” button 304 can be selected if the user of the device wishes to edit any of the extracted pieces of situation-feature information. Application-entry object 306 comprises an associated application service of sharing the original text message via text message with another user. For example, in the event that application-entry object 306 is activated, the text messaging service application would launch at the device and solicit the contact information of another user with which to send the original text message. Application-entry object 308 comprises an associated application service of requesting a taxi service to drive to Xihu In City Mall with a predicted fare of $22. For example, in the event that application-entry object 308 is activated, the taxi requesting service application would launch at the device and automatically send a request for a taxi to take the user from the current location of the device to Xihu In City Mall. Application-entry object 310 comprises an associated application service of getting directions to Xihu In City Mall. For example, in the event that application-entry object 310 is activated, the navigation service application would launch at the device and provide directions from the current location of the device to Xihu In City Mall. Application-entry object 312 comprises an associated application service of dialing the phone number of contact person “Mr. Yu.” For example, in the event that application-entry object 312 is activated, the phone dialing service application would launch at the device and automatically dial the stored phone number, (510) 555-9876, of contact person “Mr. Yu.”

As illustrated by the example of FIG. 3, embodiments of the present application provide various advantages. For example, while the user of the device may recognize that the “Mr. Yu” of the original text message is a stored contact, the user is also presented with application-entry object 312, which offers to automatically call “Mr. Yu” in the event that the user wishes to call “Mr. Yu.” Therefore, embodiments of the present application make direct use of the contact person “Mr. Yu” that is extracted from the text message as a piece of situation-feature information as a basis for providing the user with “Mr. Yu's” telephone number (which is additional information determined based on the situation-feature information), thereby sparing the user the operation of looking up this contact. Also, for example, while the user of the device may recognize that Xihu In City Mall of the original text message is a building name, the user is also presented with application-entry objects 308 and 310, which respectively offer to help the user get to Xihu In City Mall. Therefore, embodiments of the present application make direct use of the location of Xihu In City Mall that is extracted from the text message as a piece of situation-feature information and the supplementary information of its address for providing the user with the associated application service of requesting a taxi and the associated application service of providing navigation, therefore sparing the user from performing the operations of looking up the address of Xihu In City Mall and inputting such an address in either a taxi requesting service application or a navigation service application.

Similarly, in another example, if a text message contains information such as a flight number, the user may wish to learn of and/or receive services in association with this flight number. Specifically, for example, if a user purchases a ticket and receives a confirmation in a text message sent by the airline associated with the booked flight, the text message may contain the flight number, the departure location, the flight departure time, the flight arrival time, and the flight arrival location. If the flight departure location is Shanghai and the flight arrival location is Beijing, then the user may be wondering how to take a taxi to the airport in Shanghai, how to go to the check-in counter, what the weather in Beijing will be like, what activities there are to do in Beijing, and other such information. Embodiments of the present application would make it possible to obtain additional information to supplement the extracted situation-feature information of the departure location of Shanghai and the arrival location of Beijing by determining the departure and arrival airports by using the flight number and also providing the user with application-entry objects for a navigation service application to get to/from either airport, a taxi-booking service application to get to/from either airport, for online check-in, and for obtaining the weather at the arrival location. The obtained additional information can also be displayed to the user. This way, the user need only input their identification card to select a seat online and is also informed on what appropriate clothing for the trip to pack.

The card object described above is only one example form of displaying the original message, the extracted situation-feature information, additional information, and/or application-entry objects. In actual implementation, other forms of displaying the original message, the extracted situation-feature information, additional information, and/or application-entry objects may be used in addition to or alternative to card objects. For example, if the received message comprises a text message, the situation-feature information and application-entry object may be located in the text message interface. Or in another example, if the text information is an instant-messaging message, then the situation-feature information and application-entry object may be loaded in the dialogue window of the instant-messaging tool, etc. Embodiments of the present application impose no restrictions in this regard.

Returning to FIG. 2, at 211, an indication that an application-entry object among the one or more application-entry objects is to be activated is received. In various embodiments, a user can activate a presented application-entry object by selecting it (e.g., by clicking on it or touching it via touchscreen).

At 212, in response to an activation of the application-entry object, an application is invoked to perform a service corresponding to the application-entry object. In various embodiments, each category of application-entry object has a default corresponding application to invoke in response to the activation of the application-entry object. In some embodiments, the default corresponding application is determined based on the application-entry template from which the application-entry object was based. In some embodiments, the predetermined relationships between applications and application-entry objects/templates are configured in a file, which can be stored locally and/or at a remote server.

In response to a user activation of a presented application-entry object, the application corresponding to the application-entry object can be looked up among the applications executing locally at the device. In some embodiments, the application corresponding to the application-entry object can be determined based on predetermined correspondences between application-entry templates and associated application service(s). The application corresponding to the application-entry object can be an application that provides at least one of the associated application services that corresponds to the application-entry template from which the application-entry object was generated. In the event that the application corresponding to the application-entry object is not found locally at the device, then an online version of the application corresponding to the application-entry object can be invoked using a web browser executing at the device. For example, the online version of the application can be invoked by the application-entry object invoking a web browser application to access the link associated with the online version of the application.

Regardless if a version of the application that is local to the device or a version of the application that is found online is used, in various embodiments, the application is invoked by sending any of the situation-feature information and/or additional information that is included in the activated application-entry object to the application.

For example, if the user activates application-entry object 310 of FIG. 3, then a corresponding navigation service application is to be invoked to provide directions from the current location of the device to Xihu In City Mall. For example, a navigation service application that is executing locally at the device, such as a map application, is first searched for. If such a local map application is found locally at the device, then the map application is invoked and the destination of Xihu In City Mall is sent to the map application to cause the map application to provide directions to this destination. However, if a navigation service application that is executing locally at the device cannot be found at the device, then the destination of the Xihu In City Mall can be sent via a preset browser executing locally at the device to an online application that provides a navigation service, e.g., to an electronic map platform server. The directions and/or map that is provided by the electronic map platform server is then loaded into the browser and provided at the device.

FIG. 4 is a flow diagram showing an example process of obtaining content from a message received at a device that is executing an Android operating system. In some embodiments, process 400 is implemented at system 100 of FIG. 1. Specifically, in some embodiments, process 400 is implemented at device 104 of system 100 of FIG. 1. In some embodiments, step 202 of process 200 can be implemented using process 400.

At 402, a communication sent by a second operating system executing at a second device is received at a first operating system executing at a first device. The first operating system searches for a text message that corresponds to the communications at the first device. The communication sent from the second device includes identifying information associated with the first device to which it is destined. For example, the communication comprises a broadcast sent by the operating system of the second device.

In an Android operating system, text message receiving authorizations and text message received alert communications may be set up in advance.

For example, when an Android operating system receives a new communication associated with a new text message, it can automatically send a text message received alert communication to a notification center executing at the same device.

Specifically, text messages in the notification center may be ranked in descending order. For example, the text message that is ranked first is the newly received text message.

At 404, a message corresponding to the communication is extracted from a notification center associated with the first device. When a monitoring process executing at the first device detects that the notification center program executing at the first device has received a message, e.g., an instant-messaging message associated with an instant-messaging tool, the message is extracted from the notification center.

For example, the notification center may receive information (e.g., emails and instant-messaging messages) from various applications that are executing at the first device. If the monitoring process detects that the notification center has received needed application information at an application, such as a mailbox client or an instant-messaging tool, then the needed application information, such as an email or an instant-messaging message, is extracted from the notification center. The text, audio, image, and/or other content can then be obtained from the extracted message.

Other text information may be obtained via other ways. For example, a text-information alert may be directly sent from an appropriate application and then the text message could be extracted by an application programming interface (API) provided by the appropriate application. Embodiments of the present application do not impose restrictions in this regard.

FIG. 5 is a flow diagram showing examples of extracting one or more pieces of situation-feature information from content obtained from a message. In some embodiments, process 500 is implemented at system 100 of FIG. 1. Specifically, in some embodiments, process 500 is implemented at device 104 of system 100 of FIG. 1. In some embodiments, step 204 of process 200 can be implemented using process 500.

Process 500 is an example process of extracting one or more pieces of situation-feature information from the content (e.g., text information) obtained from a received message. As described above, a type of situation-feature information with regular text formatting and/or that was received from an information source that is identifiable using data stored locally at the device can be directly identified based on standardized text formatting, its information source, and/or in some other manner applied locally at the device. As such, process 500 is an example process of extracting pieces of situation-feature information that comply with one or more preset text formats.

In some embodiments, the text formatting of some types of pieces of situation-feature information (e.g., time, address, flight number, train number, telephone number, etc.) may be regular. Thus, it is possible to extract such types of pieces of situation-feature information from the content (e.g., text information) obtained from the received message using regular expressions. In some embodiments, extracting such types of pieces of situation-feature information from the content (e.g., text information) obtained from the received message using regular expressions can be performed at the device at which the message is received.

At 502, time information, if any, is extracted by comparing content obtained from a received message to one or more regular expressions associated with numerical unification and date conversion.

For example, the time may include date(s) and/or time point(s). As for the date, it is generally an absolute date in a regular format such as “XX-XX-XX,” “Year XX Month XX Day XX,” or “XX.XX.XX,” for example. The date can also be a relative date in text format such as “tomorrow” or “yesterday.” As for time points, they are generally in a regular format such as “X o'clock,” “half past X,” or “XX:XX,” where X is a number, including Chinese numerals, Arabic numerals, etc.

Extracting time information by comparing the content obtained from the received message to one or more regular expressions comprises extracting a set of time information that complies with a time-related expression from the content obtained from the received message.

For example, an absolute date may be directly extracted from the content obtained from the received message using a time-regular expression. For example, the absolute date of “2014-8-19” or “August 25th” may be directly extracted.

In the present example, the regular expression for extracting the time (such as date) may be: (([0-9]|(0|1|2|3|4|5|6|7|8|9|10)){4}(−|/|year))?(([0-1]?[0-9]|(0|1|2|3|4|5|6|7|8|9|10){1,2})(−|/|month)((([0-2]?[0-9])|(3[0-1]))(?![0-9])|(0|1|2|3|4|5|6|7|8|9|10){1,3})(day|date)?).

In the case of the date “Oct. 8, 2014,” the process of extracting the date may comprise extracting the year “2014” according to the regular expression ([0-9]|(0|1|2|3|4|5|6|7|8|9|10)){4}(−|/|year), extracting the month “October” according to the regular expression (([0-1]?[0-9]|(0|1|2|3|4|5|6|7|8|9|10){1,2})(−|/|month)), and finally extracting the day “8” according to the regular expression ((([0-2]?[0-9])|(3[0-1]))(?![0-9])|(0|1|2|3|4|5|6|7|8|9|10){1,3})(day|date)?).

In some embodiments, date conversion may be as follows: determine if the extracted time is a relative date and if so, convert the relative date to an absolute date. For example, a relative date may be extracted using a regular expression and this relative date may be converted to an absolute date. For example, assuming that the current date is Jan. 1, 2015, if the extracted relative date is “tomorrow,” then the relative date can be converted to Jan. 2, 2015.

For example, time points such as “8 o'clock” and “9:30” may be extracted using regular expressions.

In some embodiments, “numerical unification” may comprise the following: converting various numerical formats extracted from the content obtained from the received message into a uniform format.

Furthermore, to make regular expressions easier to use, in some embodiments, Chinese numerals, Arabic numerals, and other numerical forms that are extracted from the content obtained from the received message are unified prior to time extraction.

Because Chinese numeral coding is not continuous and has diverse forms of expression, in some embodiments, any Chinese numerals from the content obtained from the received message are converted to their corresponding Arabic numerals. For example, “ [symbol] [five]” is replaced by “5,” and “ [symbol] [twenty seven]” is replaced by “27.”

In some embodiments, if no time is mentioned in the content, then the current date can be presumed/extracted as the relevant time information of the content.

At 504, address information, if any, is extracted by comparing the content obtained from the received message to one or more address related regular expressions.

In various embodiments, the address information includes one or more geographic markers. For example, the address in regularly formatted text commonly includes geographic markers such as city, district, county, and/or street. The following is an example process of extracting address information from text information content obtained from the received message:

1) Segment a portion of the text information to word segmentation before a first geographic marker using a common place name information source.

In some embodiments, geographic markers could refer to phrases that carry geographic information such as city, district, county, or street. In some embodiments, a geographic marker in the text information of a message is identified using a geographic marker related regular expression. An example regular expression to use to identify a geographic marker is: “ [symbol] [symbol] [symbol] [symbol] ” [Province|City|District|County|Autonomous Prefecture|Autonomous District|Town|Township|Village|Street|Avenue|Road|Garden|Tower|Floor|Number|Level|Block|P ark|Building].

In this example, the first geographic marker of the text information of the message can be identified using a geographic marker related regular expression. Because the extracted information generally lacks a prefix for the first geographic marker, a database of commonplace names (e.g., a word bank for storing common place generic places, such as the names of provinces, cities, districts, and counties) can be used to subject the information that precedes a geographic marker (generally, the first geographic marker) to word segmentation.

If the word segmentation is successful (i.e., the portion of the text information before the first geographic marker is found to contain commonplace names in the database), then the word segment (e.g., the largest word segment) that precedes the first geographic marker is determined as the prefix of the address information. If an example text information comprises “Come tomorrow to hold a meeting at Hangzhou City, No. 969 Wenyi Road, First Floor,” “Hangzhou City, No. 969 Wenyi Road, First Floor” can be extracted. In this example set of text information, there are the four geographic markers “City,” “Road,” “Number,” and “Floor,” but the prefix “Hangzhou” to the first geographic marker “City” is missing. At this point, the information “Come tomorrow . . . Hangzhou” in front of “City” can undergo word segmentation to determine the word segment “Hangzhou” as the prefix. Furthermore, the largest word segment may refer to the longest word that has been matched from the text information to an entry in the database. For example, the text is ABCD, and both BCD and CD are matched to place names in the database. Therefore, there are two word-segmentation results that comprise BCD and CD. Because BCD is longer than CD, BCD is determined as the largest word segment and also the prefix of the address information. In the example above, each of “Hang” and “zhou” are separately matched to entries in the database and the combination of “Hangzhou” is also matched to an entry in the database. Because “Hangzhou” is longer than either of “Hang” and “zhou,” “Hangzhou” is determined as the prefix of the address information.

If the word segmentation fails (i.e., the prefix information is found not to contain commonplace names in the database), then a search through the portion of the text information from the first geographic marker towards the start of the text information for the first word that is in a language that is different from the language of the geographic marker occurs and this word is determined as the prefix. For example, if the geographic marker comprises Chinese characters, then the first non-Chinese character that is found is determined as the prefix of the address information. For example, a predetermined maximum of N words is searched in the portion of the text information that precedes the first geographic marker. If there are more than N words, then the first N words can be regarded as the prefix of the address information.

At 506, flight information, if any, is extracted by comparing the content obtained from the received message to one or more flight information related regular expressions. In another example, flight numbers are generally subject to uniform numbering rules. Domestic flight numbers are generally formed from the two-letter code of the airline plus four numbers and international flight numbers are formed from the two letter code of the airline plus three numbers. The airline's two-letter code is generally composed of upper-case letters of the English alphabet or numerals.

Thus, in the present example, a flight number can be extracted from the text information using a flight number regular expression.

For example, the flight number regular expression that is used for extracting flight numbers could be:

((([A-Z][0-9])|([0-9][A-Z])|([A-Z]{2}))\\d{3,4})(?![a-zA-Z0-9]).

In the case of flight number “CA1703,” “CA” satisfies the regular expression ((([A-Z][0-9])|([0-9][A-Z])|([A-Z]{2})) and “1703” satisfies the regular expression “\\d{3,4}.”

At 508, train ride information, if any, is extracted by comparing the content obtained from the received message to one or more train ride information related regular expressions. In another example, the general, uniform numbering rule for train numbers is as follows: The domestic train code generally begins with C, D, G, Z, T, K or L and is accompanied by a four-digit number or the domestic train code is directly composed of a four-digit number.

Thus, in the present example, a train number can be extracted from the text information using a train number regular expression.

For example, the train number regular expression that is used for extracting train numbers could be:

[A-Z]?\\d{1,5}(?![a-zA-Z0-9]).

In the case of train number “T257,” the first character is “T,” and it is followed by a 3-digit number, which satisfies the regular expression.

At 510, telephone information, if any, is extracted by comparing the content obtained from the received message to one or more telephone information related regular expression. In another example, telephone numbers generally have relatively regular numbering rules. For example, in China, a mobile phone number has an 11-digit number, and a landline number is a 3- or 4-digit area code plus a 7- or 8-digit direct-dialing number followed by a 1-to-4-digit extension.

Thus, in the present example, a telephone number can be extracted from the text information using a telephone number regular expression.

For example, the telephone number regular expression that is used for extracting telephone numbers could be:

(((\\+86)?1[0-9]{10})|((0[0-9]{2,3}−)?[0-9]{7,8}))(?![a-zA-Z0-9])

In the case of “+8613800008888,” there is the “+86” and then the first number “1,” which is followed by a 10-digit number, which satisfies the regular expression.

Of course, the techniques of extracting the situation-feature information described above are only examples. Other regular expressions can be used to extract other types of situation-feature information. Other extraction techniques to extract the same or different types of information can be used in actual implementation. Embodiments of the present application impose no restrictions in this regard.

At 512, a piece of situation-feature information, if any, is extracted by comparing the content obtained from the received message to a local preset information source. The user of the device may store various kinds of information at the device that can serve as local preset information sources. As one example, the contact list stored at the device may comprise a local preset information source. For example, in a device such as a mobile phone, the user may record contact information, such as names, telephone numbers, and company names, in a contact list. For example, a name within the contact list is matched against the text information of the message and if the match is successful, then a portion of the text information that matches an entry in the contact list is extracted as a piece of situation-feature information.

The following are examples of various different pieces of situation-feature information that are extracted from corresponding messages (e.g., using example techniques described in process 500, above):

In this example, the current date is Jan. 1, 2015. The following are example situation-feature information pieces extracted from corresponding text information:

| Text | Situation-feature |
|---|---|
| information | information |
| “I purchased a train ticket for January 15. | Time: Jan. 15, 2015 |
| The train number is G7519.” | Train number: G7519 |
| “Let's go see The Taking of Tiger Mountain | Time: Jan. 2, 2015 |
| tomorrow. </976>” | Title of movie: The Taking |
| | of Tiger Mountain |
| “Already booked tomorrow's flight for you. | Time: Jan. 2, 2015 |
| The flight number is CA1703.” | Flight number: CA1703 |
| “Come to International Plaza in Xihu District | Time: Jan. 2, 2015, |
| for the meeting at 8:30 tomorrow morning. | 8:30 am |
| Please pass this information on to Jimmy.” | Address: International |
| | Plaza, Xihu District |
| | Contact person: Jimmy |
| “My telephone number is 13925642014. You | Time: Jan. 2, 2015, |
| may contact me at any time before 8:00 | 8:00 pm |
| tomorrow evening.” | Telephone number: |
| | 13925642014 |

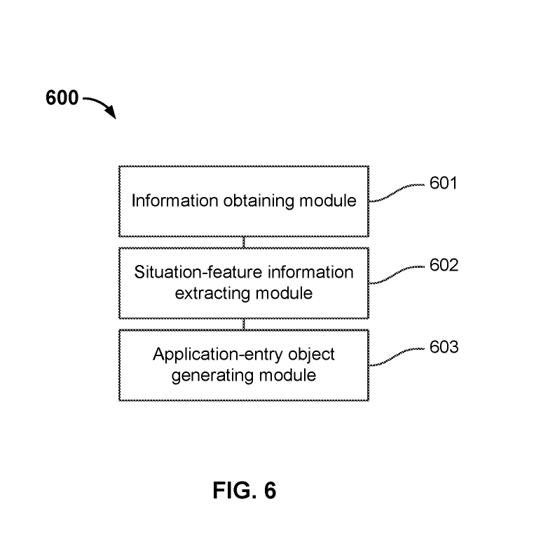

FIG. 6 is a diagram showing an embodiment of a device for invoking an application to perform a service based on message content. In the example, device 600 includes information obtaining module 601, situation-feature information extracting module 602, and application-entry object generating module 603.

The modules and sub-modules can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and sub-modules may be implemented on a single device or distributed across multiple devices.

Information obtaining module 601 is configured to obtain content, such as images, audio, video, and/or text from messages received at device 600.

Situation-feature information extracting module 602 is configured to extract one or more pieces of situation-feature information from the content obtained from a message.

Application-entry object generating module 603 is configured to generate one or more application-entry objects based on the one or more pieces of situation-feature information.

In some embodiments, the content obtained from the message may comprise a text message or an instant-messaging message. In some embodiments information obtaining module 601 may comprise at least one of the following sub-modules:

A text-message search sub-module that is configured to look up text messages corresponding to a communication in the operating system executing at device 600 when the communication sent by another operating system is received.

An instant-messaging extracting module that is configured to extract an instant-messaging message of an instant-messaging tool from the notification center program executing at device 600 when a monitoring process detects that the notification center program has received an instant-messaging message of an instant-messaging tool.

In some embodiments, situation-feature information extracting module 602 may comprise the following sub-module:

A local-extracting sub-module that is configured to locally extract (e.g., extract at device 600 that received the message) one or more pieces of situation-feature information from the text information.

In some embodiments, situation-feature information extracting module 602 may further comprise the following sub-module:

An information-supplementing sub-module that is configured to determine additional information to supplement the one or more pieces of situation-feature information.

In some embodiments, the local-extracting sub-module of situation-feature information extracting module 602 may comprise the following sub-module:

A first extracting sub-module that is configured to extract from the text information of the received message situation-feature information that complies with a preset text format.

In some embodiments, the local-extracting sub-module of situation-feature information extracting module 602 may comprise the following sub-module:

A second extracting sub-module that is configured to extract from the text information of the received message situation-feature information that matches a local preset information source.

In some embodiments, the information-supplementing sub-module of situation-feature information extracting module 602 may comprise the following sub-modules:

A first sending sub-module that is configured to send the one or more pieces of the situation-feature information to an additional information management server;

A first receiving sub-module that is configured to receive one or more pieces of situation-feature information that were sent back by the additional information management server and that were obtained by the server looking up associated information in one or more first data sets and supplementing information stored by the server.

In some embodiments, the information-supplementing sub-module of situation-feature information extracting module 602 may comprise the following sub-module:

A local-supplementing sub-module that is configured to use the one or more pieces of situation-feature information as key words in performing searches local to device 600 at which the message was received for additional information to supplement the situation-extraction information.

In some embodiments, the information-supplementing sub-module of situation-feature information extracting module 602 may comprise the following sub-modules:

A first sending sub-module configured to send the text information of the received message to an additional information management server.

A second receiving sub-module configured to receive one or more pieces of situation-feature information sent back by the server that are extracted from the text information.

In some embodiments, the one or more pieces of situation-feature information are extracted and obtained from the text information by an additional information management server, or, the one or more pieces of situation-feature information and additional information are determined to supplement the situation-feature information by looking up additional information in one or more data sets using one or more pieces of situation-feature information extracted from the text information from the received message as key words.

In some embodiments, application-entry object generating module 603 may comprise the following sub-module:

An embedding sub-module configured to embed the situation-feature information, the additional information determined based on the situation-feature information, if any, and the associated application service(s) corresponding to the situation-feature information are embedded into one or more user interface elements to generate one or more application-entry objects.

In some embodiments, device 600 may further comprise the following modules:

A card template looking up module that is configured to look up card templates corresponding to the one or more pieces of situation-feature information.

A card-object-generating module that is configured to load the one or more pieces of situation-feature information and the one or more application-entry objects into the looked up card templates to generate card objects.

In some embodiments, device 600 may further comprise the following module:

An application invoking module that is configured to send, when the application-entry object is activated, the situation-feature information and/or additional information in the application-entry object to an application corresponding to the application-entry object so as to invoke the application to provide a related service.

In some embodiments, the application invoking module may comprise the following sub-modules:

An application looking-up sub-module that is configured to look up the application corresponding to the application-entry object locally at device 600 in response to the activation of the application-entry object. If the application is found locally at device 600, then a third sending sub-module is invoked. Otherwise, if the application is not found locally at device 600, then a fourth sending sub-module is invoked.

The third sending sub-module is configured to send the situation-feature information in the activated application-entry object to the found local application.

The fourth sending sub-module is configured to send the situation-feature information in the activated application-entry object to an online application via a web browser.

In some embodiments, the situation-feature information comprises the following one or more categories:

time, address, flight number, train number, telephone number, contact person, and video title.

In some embodiments, the first extracting sub-module of the local extracting sub-module of situation-feature information extracting module 602 may comprise the following sub-module:

A time-extracting sub-module that is configured to locally compare the text information from a received message to a regular expression associated with one or more of the following: numerical unification and date conversion, in order to extract the time.

In some embodiments, the first extracting sub-module of the local extracting sub-module of situation-feature information extracting module 602 may comprise the following sub-modules:

An address-extracting sub-module that is configured to extract from the text information from a received message an address that complies with an address related regular expression, where the address includes a geographic marker.

A word-segmentation sub-module that is configured to subject the text information before the geographic marker to word segmentation using a common place name database. If the word segmentation is successful, the word-segmentation sub-module is configured to invoke a first setting sub-module and if the word segmentation fails, the word-segmentation sub-module is configured to invoke a second setting sub-module.

A first setting sub-module that is configured to set the word segment adjacent to the geographic marker as the prefix to the address.

A second setting sub-module that is configured to set the text information between the first geographic marker and the first preceding word that is in a language different than the language of the geographic marker to the prefix to the address.

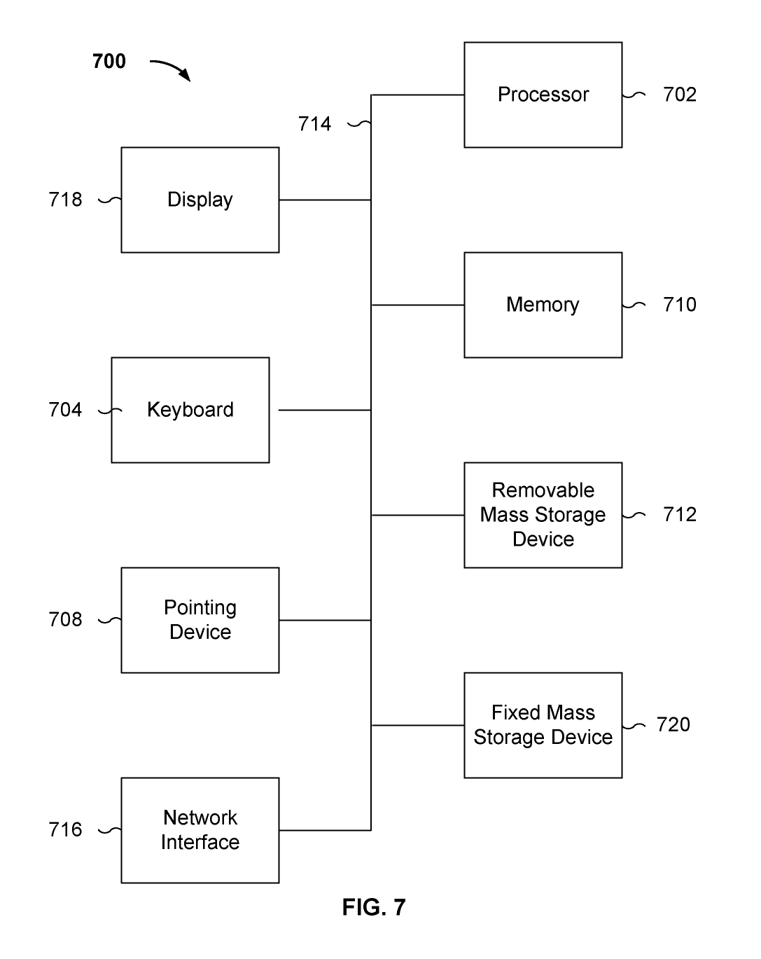

FIG. 7 is a functional diagram illustrating an embodiment of a programmed computer system for invoking an application to perform a service based on message content. As will be apparent, other computer system architectures and configurations can be used to invoke an application to perform a service based on message content. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718).

Processor 702 is coupled bi-directionally with memory 710, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700 and is coupled either bi-directionally (read/write) or uni-directionally (read only) to processor 702. For example, storage 712 can also include computer readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display 718, a network interface 716, a keyboard 704, and a pointing device 708, as well as an auxiliary input/output device interface, a sound card, speakers, and other subsystems as needed. For example, the pointing device 708 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

Each of the embodiments contained in this description is described in a progressive manner, the explanation of each embodiment focuses on areas of difference from the other embodiments, and the descriptions thereof may be mutually referenced for portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, embodiments of the present application may employ one or more forms of computer products that implement computer-operable storage media (including but not limited to magnetic disk storage devices, CD-ROMs, and optical storage devices) containing computer-operable computer code.

In one typical configuration, the computer equipment comprises one or more processors (CPUs), input/output interfaces, network interfaces, and memory. Memory may include such forms as volatile storage devices in computer-readable media, random access memory (RAM) and/or non-volatile memory, such as read-only memory (ROM) or flash memory (flash RAM). A storage device is an example of a computer-readable medium. Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include transitory computer-readable media, (transitory media), such as modulated data signals and carrier waves.

The embodiments of the present application are described with reference to flowcharts and/or block diagrams based on methods, terminal equipment (systems), and computer program products of the embodiments of the present application. Please note that each flow chart and/or block diagram within the flowcharts and/or block diagrams and combinations of flow charts and/or block diagrams within the flowcharts and/or block diagrams can be realized by computer commands. These computer program commands can be provided to the processors of general-purpose computers, specialized computers, embedded processor devices, or other programmable data processing terminals to produce a machine. The commands executed by the processors of the computers or other programmable data processing terminal equipment consequently give rise to devices for implementing the functions specified in one or more processes in the flowcharts and/or one or more blocks in the block diagrams.

These computer program commands can also be stored in computer-readable memory that can guide the computers or other programmable data processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data processing terminal equipment and made to execute a series of steps on the computers or other programmable data processing terminal equipment so as to give rise to computer-implemented processing. The commands executed on the computers or other programmable data processing terminal equipment thereby provide the steps of the functions specified in one or more processes in the flowcharts and/or one or more blocks in the block diagrams.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the embodiments of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor; and
a memory coupled with the processor, wherein the memory is configured to provide the processor with instructions which when executed cause the processor to:
obtain content from a message received at a device;
extract situation-feature information from the content;
generate one or more application-entry objects based at least in part on the situation-feature information;
present the one or more application-entry objects at the device;
receive an indication that an application-entry object among the one or more application-entry objects is to be activated; and
in response to an activation of the application-entry object, invoke an application to perform a service corresponding to the application-entry object.

2. The system of claim 1, wherein the memory is further configured to provide the processor with instructions which when executed cause the processor to determine additional information based at least in part on the situation-feature information.

3. The system of claim 1, wherein the memory is further configured to provide the processor with instructions which when executed cause the processor to determine additional information based at least in part on the situation-feature information and wherein the one or more application-entry objects are generated further based at least in part on the additional information.

4. The system of claim 1, wherein the memory is further configured to provide the processor with instructions which when executed cause the processor to determine additional information based at least in part on the situation-feature information and wherein to invoke the application to perform the service corresponding to the application-entry object uses at least a portion of the additional information.

5. The system of claim 1, wherein the memory is further configured to provide the processor with instructions which when executed cause the processor to determine additional information based at least in part on the situation-feature information and predetermined associative relationships between the situation-feature information and required supplementary information.

6. The system of claim 1, wherein to invoke the application to perform the service corresponding to the application-entry object comprises using at least a portion of the situation-feature information.

7. The system of claim 1, wherein to extract the situation-feature information from the content comprises to compare the content to one or more regular expressions.

8. The system of claim 1, wherein to extract the situation-feature information from the content comprises to compare the content to one or more regular expressions and wherein the one or more regular expressions are associated with one or more of the following: time information, address information, flight information, train ride information, or telephone information.

9. The system of claim 1, wherein to extract the situation-feature information from the is content comprises to compare the content to a local preset information source at the device.

10. The system of claim 1, wherein to generate the one or more application-entry objects based at least in part on the situation-feature information comprises to:
determine an application-entry template corresponding to a category associated with a first piece of the situation-feature information; and
generate a first application-entry object based at least in part on embedding at least a portion of the first piece of the situation-feature information as a parameter in the application-entry template.

11. The system of claim 1, wherein to present the one or more application-entry objects at the device comprises to:
generate a card object based at least in part on loading one or both of the content and a first piece of the situation-feature information into a card template; and
present the card object at the device.

12. The system of claim 1, wherein to invoke the application to perform the service corresponding to the application-entry object comprises to send at least a portion of the situation-feature information associated with the application-entry object to the application.

13. The system of claim 1, wherein to invoke the application to perform the service corresponding to the application-entry object comprises to send at least a portion of the situation-feature information associated with the application-entry object to the application, and wherein the application is executing at the device.

14. The system of claim 1, wherein to invoke the application to perform the service corresponding to the application-entry object comprises to send at least a portion of the situation-feature information associated with the application-entry object to the application, and wherein the application comprises an online application accessible by a web browser application executing at the device.

15. A method, comprising:
obtaining content from a message received at a device;
extracting situation-feature information from the content;
generating, using a processor, one or more application-entry objects based at least in part on the situation-feature information;
presenting the one or more application-entry objects at the device;
receiving an indication that an application-entry object among the one or more application-entry objects is to be activated; and
in response to an activation of an application-entry object, invoking an application to perform a service corresponding to the application-entry object.

16. The method of claim 15, wherein extracting the situation-feature information from the content comprises comparing the content to one or more regular expressions.

17. The method of claim 15, wherein extracting the situation-feature information from the content comprises comparing the content to one or more regular expressions and wherein the one or more regular expressions are associated with one or more of the following: time information, address information, flight information, train ride information, or telephone information.

18. The method of claim 15, wherein extracting the situation-feature information from the content comprises comparing the content to a local preset information source at the device.

19. The method of claim 15, wherein generating the one or more application-entry objects based at least in part on the situation-feature information comprises:
determining an application-entry template corresponding to a category associated with a first piece of the situation-feature information; and
generating a first application-entry object based at least in part on embedding at least a portion of the first piece of the situation-feature information as a parameter in the application-entry template.

20. A computer program product, the computer program product comprises a computer readable storage medium and comprising computer instructions for:
obtaining content from a message received at a device;
extracting situation-feature information from the content;
generating one or more application-entry objects based at least in part on the situation-feature information;
presenting the one or more application-entry objects at the device;
receiving an indication that an application-entry object among the one or more application-entry objects is to be activated; and
in response to an activation of the application-entry object, invoking an application to perform a service corresponding to the application-entry object.
